(19) United States
(12) Patent Application Publication
(10) Pub. No.: US 2005/0105003 A1
(43) Pub. Date: May 19, 2005

(54) Television receiving system

(75) Inventor: Gerardus Wilhelmus Theodorus Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/509,240

(22) PCT Filed: Mar. 26, 2003
(86) PCT No.: PCT/IB03/01209

(30) Foreign Application Priority Data
Mar. 29, 2002 (EP) 02076297.7

(51) Int. Cl. H04N 5/45

(52) U.S. Cl. 348/565; 348/588

(57) ABSTRACT

A television receiving system (1) has at least two inputs (3, 5) for incoming television signals and comprises a processing unit (7) which allows the construction of two outgoing television signals leaving the television receiving system (1) at two television signal outputs (9, 11). The construction is based on the picture information of at least one of the incoming television signals, or on a predetermined picture, or on a combination of both. The television receiving system allows construction of the first outgoing television signal with picture information of the second outgoing television signal. An envisaged application is parental control. Parents can check by means of the first outgoing television signal what information is present in the second outgoing television signal, and if this information is deemed unsuitable, the parents can block the supply of the second outgoing television signal.

The invention relates to a television receiving system having a first input for a first incoming television signal and a second input for a second incoming television signal, both being coupled to a common processing unit for television signals, and a first output for supplying a first outgoing television signal coming from the processing unit to a first television receiving station comprising a display screen, and a second output for supplying a second outgoing television signal coming from the processing unit to a second television receiving station.

An embodiment of such a television receiving system is known from U.S. Pat. No. 5,933,192.

The known system has two television signal inputs, each with its own tuner. There are different reasons that television receiving systems have a plurality of television signal inputs. Signals may come from different signal sources, for example, a first signal from the air via an antenna, and a second signal from a DVD player. Television signals comprise picture information, sound information and may comprise other information such as, for example, teletext information. The use of two tuners may be interesting when one wants to simultaneously have the disposal of information in two television channels. A shorter program change time is aimed at with the known system because it takes too long for one tuner before a signal from a new television channel has been decoded. Another example is a picture display device which shows the information of both channels simultaneously, for example, the contents of a second channel in which a viewer is interested is displayed in a small window, referred to as picture-in-picture (PIP).

It is a drawback of the known system that it can only supply a tuned, incoming television signal from an output.

It is, inter alia, an object of the invention to provide a television receiving system having more facilities than the known system.

This object is realized in that the processing unit comprises means for constructing at least one of the outgoing television signals from the incoming television signal and is capable of processing at least a part of the second outgoing television signal in the first outgoing television signal, the processing unit also comprising user interface software for specifying the outgoing television signals.

A display screen is, for example, a cathode ray tube or an LCD panel. A television receiving station without a display screen is, for example, a video cassette recorder or a set-top box or a computer. An additional advantage is that the means used for constructing the outgoing television signals from the incoming television signals can also be used for constructing outgoing television signals which comprise internally generated picture information, for example, a game.

In one embodiment of the television receiving system, each input is connected to its own tuner. In this way, information from two tuned channels can be used for both outgoing television signals, whereas, when using only one tuner, the second incoming television signal can only originate from a television signal source for which no tuner is required, such as a video cassette recorder.

It is interesting when the processing unit of the television receiving system is capable of constructing a first outgoing television signal which is displayed on the display screen of the television receiving station, in which at least a part of the second outgoing television signal is shown on the display screen of the television receiving station in accordance with one of the following methods:
the first outgoing television signal is alternated with the second;
the first outgoing television signal covers a part of the display screen of the first television receiving station, and a scaled version of a selected part of the second outgoing television signal is displayed on a portion of this part;
selected parts of both outgoing television signals are displayed next to each other on the display screen of the television receiving station.

As regards the sound information in an outgoing television signal, only one sound signal is generally constructed for the outgoing television signal, which is chosen from sound information in an incoming television signal, or sound information internally generated in the processing unit, for example, information associated with a game or a text.

The first of the above-mentioned three methods is referred to as temporal multiplexing, the second method is referred to as picture-in-picture (PIP) and the third method is referred to as picture-outside-picture (POP). The television receiving system enables the user to watch the major part of the picture information in the first outgoing television signal, but also a part of the picture information in the second outgoing television signal. Generally, the picture information of the first television signal is constructed in such a way that the picture information of the part of the second outgoing television signal, which part is displayed on the display screen of the television receiving station, is processed in the picture information of the first outgoing television signal. The part of the second outgoing television signal may, however, also be supplied after the first outgoing television signal to the television receiving station with a display screen, for which the television receiving station constructs a television picture from the two signals.

The processing unit may be arranged to block a requested supply of a constructed outgoing television signal at an output. It is particularly interesting when there is hierarchy between different constructed outgoing television signals. The television receiving system may be used by a user of the first television receiving station with display screen, which user will hereinafter be referred to as authorized user, as well as a user of the second television receiving station, which user will hereinafter be referred to as dependent user. In a first hierarchy, referred to as the equivalent hierarchy, all outgoing signals are equivalent, independent of their construction at the request of any user, and the last constructed outgoing signal is always supplied to a television receiving system. In a second hierarchy, referred to as master hierarchy, the processing unit enables the authorized user to prevent the supply by the processing unit of an outgoing television signal specified by the dependent user at an output, and it also enables the authorized user to supply an outgoing television signal specified by said user at the relevant output.

It is interesting when the processing unit of the television receiving system is incorporated in a set-top box.

Alternatively, it is interesting when the processing unit of the television receiving system is incorporated in the first television receiving station, which station may be, for example, a picture display device like a CRT or LCD based television.

These and other aspects of the invention are apparent from and will be elucidated with reference to the embodiments described hereinafter.

In the drawings:

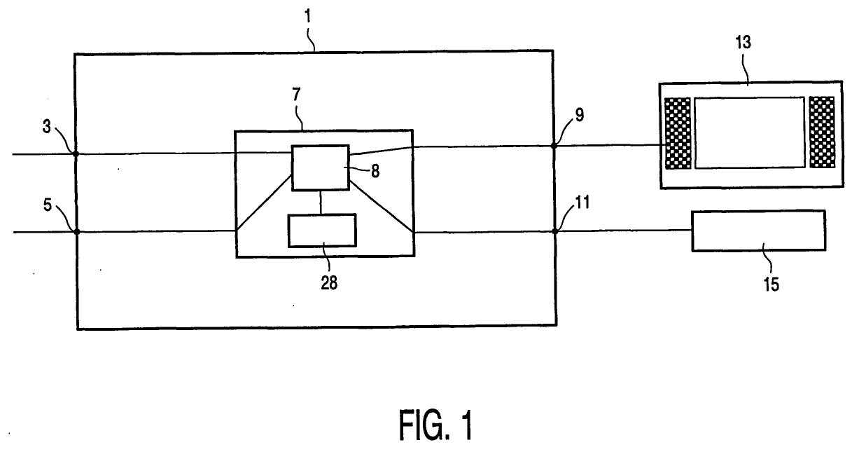

FIG. 1 shows diagrammatically the television receiving system.

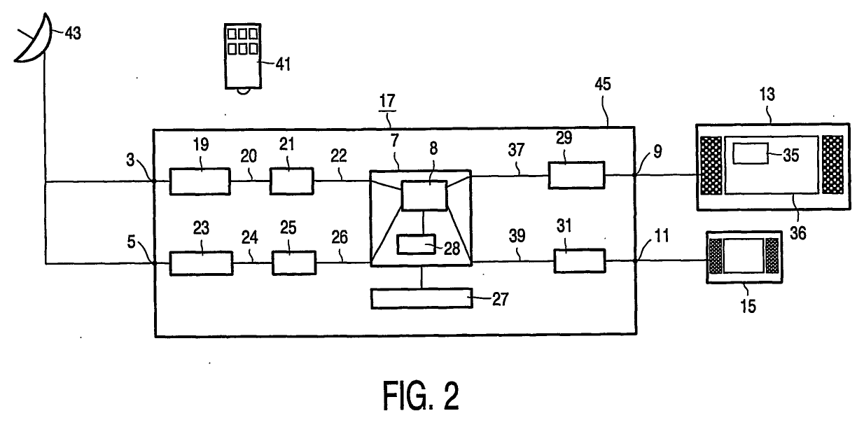

FIG. 2 shows an embodiment of the television receiving system as a set-top box.

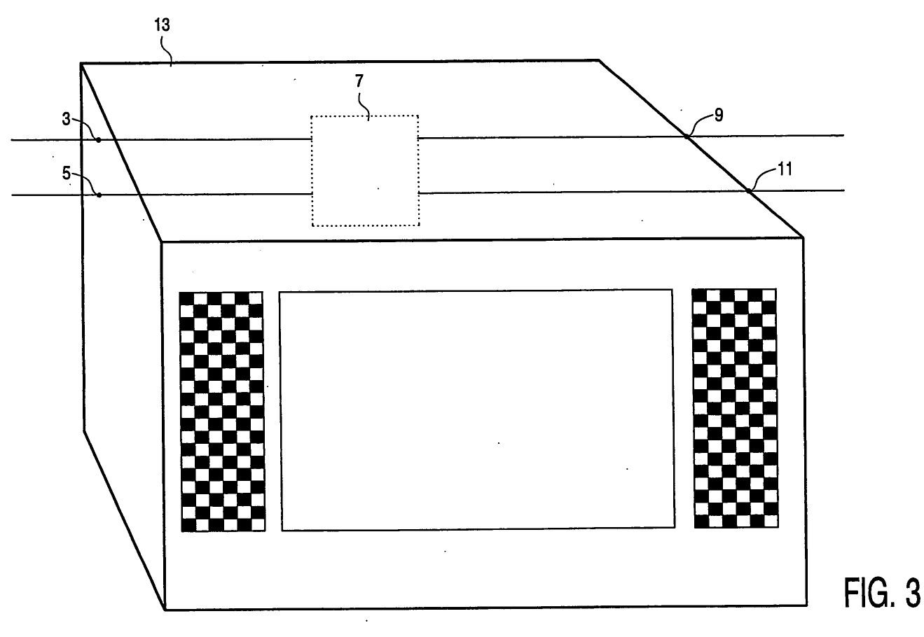

FIG. 3 shows an embodiment of the television receiving system as a picture display device.

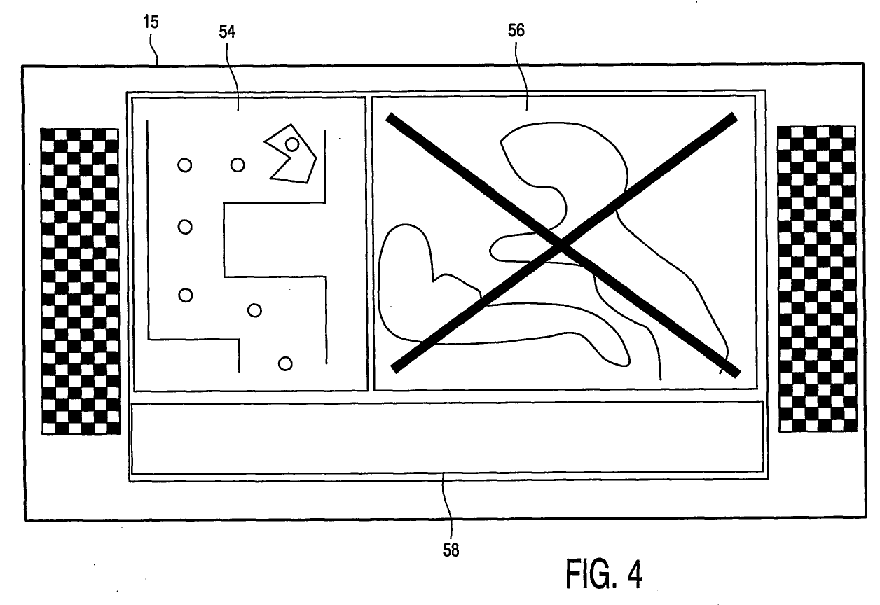

FIG. 4 shows an example of a construction of the second outgoing television signal.

Identical components in the Figures will hereinafter be denoted by the same reference numerals.

The television receiving system 1 of FIG. 1 has a first input 3 for a first incoming television signal, and a second input 5 for a second incoming television signal. An incoming television signal may originate from, for example, a satellite antenna, the Internet, or, for example, from an apparatus reading television signals from a television record carrier such as, for example, DVD or a hard disk. An apparatus supplying an incoming television signal may be accommodated with the television receiving system in one and the same apparatus. A processing unit 7 for television signals, coupled to the inputs 3 and 5, has means 8 for creating outgoing television signals from these incoming television signals. A first output 9, coupled to the processing unit 7 can supply a first outgoing television signal to a television receiving station with a display screen 13, and a second output 11, coupled to the processing unit 7, can supply a second outgoing television signal to a television receiving station 15. The television signal inputs and outputs may be implemented for cable systems for television signals such as, for example, SCART, and for a wireless signal path. Further television signal inputs and outputs (not shown) may be present, for example, for supplying a television signal to an extra picture display device or a video cassette recorder.

The television receiving station 13 with the display screen comprises, for example, a cathode ray tube or an LCD panel. In many cases, the television receiving station 15 is a picture display device, for example, a television comprising a cathode ray tube, but it may be alternatively, for example, a video cassette recorder or another apparatus which stores, or processes and passes on the television signals.

The processing unit 7 also comprises user interface software 28 enabling users of the television receiving system 1 to specify the outgoing television signals 9 and 1 1 in accordance with their wishes, both from parts of incoming television signals and from extra data such as predefined graphic images and text. The dependent user, the user of television receiving station 15, can, however, only specify television signals, or supply specified television signals to an output in so far as the authorized user, the user of the first television receiving station 13, does not revoke this. A special case of revocation is that the supply of a television signal, specified by the dependent user, to an output 9 or 11 is stopped at the request of the authorized user.

Generally, the first television receiving station 13 always receives a signal in the on-state of the television receiving system 1. The outgoing signal to be supplied to television receiving station 15 may be specified independently by the dependent user, on the one hand, but may be specified alternatively by the authorized user, on the other hand, in which case the authorized user's specification can revoke the dependent user's specification. In a first mode of operation, both outgoing television signals are specified independently by their respective users. The first television receiving station 13 receives, for example, the television signal from a first television channel, and the second television receiving station 15 receives the television signal from another television channel. In a television signal of a television channel, the information units may comprise, inter alia, a television program, a teletext page or an Internet page. More generally, a television signal is understood to be a combination of information units which come in at the inputs of the television receiving system, and information which is supplied by the television receiving system 1 itself, such as an internally stored or computed image. The television signal is shown as a television picture on a display screen.

The system according to the invention is adapted to change over to a second mode of operation, in which the first television receiving station 13 does not only receive the television signal from the television channel selected for this television receiving station, but also at least a part of the television signal from the second television receiving station 15. The authorized user can then decide how this extra information should be integrated with the television image from the outgoing television signal selected for the first television receiving station 13. Furthermore, dependent on the information which the authorized user observes in the integrated part of the television signal selected for television receiving station 15, he can decide that the television signals going to the television receiving station 15 should be constructed differently by the processing unit 7. One of the options is that the processing unit 7 no longer passes on a television signal to the television receiving station 15. Another option is that a predetermined signal is passed on to television receiving station 15, which signal consists of, for example, a text stating why the television signal is no longer supplied. Furthermore, a part of the outgoing television signal to the television receiving station 15 can be omitted, or changed into another television signal.

FIG. 2 shows an example embodiment in which the processing unit 7 is incorporated in a set-top box 45. This set-top box 45 is now connected to a satellite antenna system 43. The television receiving stations 13 and 15 are picture display devices in this Figure, but the television receiving station 15 may be alternatively, for example, a DVD recorder. The incoming television signals may not only both come from a satellite antenna system 43 but also from different sources. For example, the first incoming television signal comes from a dipole antenna and the second incoming television signal comes from a cable distribution outlet. The incoming television signals may also be received wirelessly, for example, via a mobile telephone, in which the wirelessly broadcast signal comprises, for example, predominantly text or a short, compressed film. The embodiment of the television receiving system further comprises at least two tuners 19 and 23. These tuners select a television channel. Tuned television signals 20 and 24 originate from the tuners, with analog television typically comprising one compressed television program and digital television typically comprising a plurality of compressed television programs. Optionally, the tuned television signals are subsequently transformed by transformation units 21 and 25, which supply transformed television signals 22 and 26. For analog television, the transformation units 21 and 25 could be digitizing units. For digital television, they typically perform, for example, a demultiplexing operation so that one program is selected from each tuned television signal 20 or 24, followed by a descrambling operation which decrypts the television signal, and then by a decoding operation which transforms the television signal, for example, from an MPEG2-coded television signal to a decoded television signal. Television conditioning units 29 and 31 are also optional. They may convert, for example, a digital television signal from the processing unit 7 to television signals in accordance with an analog standard such as, for example, the PAL standard. Each tuner 19 and 23, transformation units 21 and 25, processing unit 7, memory 27, and television conditioning units 29 and 31 may be formed with any combination in one physical sub-unit such as an IC. Moreover, the IC may comprise only one of each unit, for example, 21 and 25, which unit consecutively processes the television signals from the two paths.

The processing unit 7 comprises means 8 for creating processed television signals 37 and 39 from the transformed television signals 22 and 26. For this purpose, it may make use of a memory 27 in which intermediate results can be stored, as well as parameter values or predefined programs indicating how the processing unit 7 should process the transformed television signals 22 and 26. In a trivial case, the processing unit 7 does not perform an operation and the processed television signals 37 and 39 are identical to the transformed television signals 22 and 26. Alternatively, the processing unit may reduce, for example, the television image of the television signal 39 intended for the television receiving station 15 by converting, for example, a matrix of neighboring pixels into a new pixel by way of averaging. The television signal 37 intended for the television receiving station 13 can then be constructed in such a way that, somewhere, a part of the television image of the television signal 37 intended for television receiving station 13 is replaced by the smaller version of the television image intended for television receiving station 15. This is referred to as picture-in-picture (PIP), and denoted by the reference numeral 35. Any variant is possible, for example, the variant in which a part of the television image of the second outgoing television is displayed in a circular sub-area of the television image intended for television receiving station 13. Furthermore, the processing unit 7 may create a first processed television signal 37 in which a reduced version of the television image of the second outgoing television signal is placed next to a reduced version of the television image of a television signal preferred by the authorized user. This is referred to as picture-outside-picture (POP). It is also feasible that, instead of the first processed television signal 37 intended for television receiving station 13, the processing unit 7 temporarily passes on the complete second processed television signal 39 to television receiving station 13, which is referred to as temporal multiplexing.

Furthermore, the processing unit 7 may create a television image for both processed television signals, which image consists of a predefined graphic image or a text, either or not in combination with a part of the picture information of at least one of the transformed television signals 22 and 26.

The processing unit 7 also comprises user interface software 28 enabling a user of the television receiving system 17 to specify the processed television signals 37 and 39 in different ways to the discretion of the user in accordance with the above-mentioned principles. To enable the user to communicate his choice to the user interface software 28, the embodiment of FIG. 2 comprises a remote control unit 41. Remote control alternatives such as, for example, a touch screen or voice control are of course also possible. Reacting to the activation of given keys on the remote control unit by a user, the user interface software 28 may add, for example, textual menus to a television picture of a processed television signal 37 or 39. The user may also create, for example, a given PIP configuration, which creation consists of, for example, the selection of, for example, a rectangular area somewhere on a display screen, and of selecting a part of the television picture of a television signal. In principle, the dependent user has the same user interface facilities at his disposal as the authorized user, except that the authorized user always has the last say in the matter of specifying the processed signals 37 and 39.

A possible application is, for example, parental control. In this case, the authorized user can check the television signals which the dependent user watches or listens to and, if necessary, perform one of the modes of operation described above.

Another application is, for example, a game which can be played on both televisions. A possibility is a game of chess, in which the processing unit 7 creates a PIP sub-picture in two outgoing signals, which sub-picture displays the chessboard from different sides. The rest of the television image of outgoing television signals 9 and 11 can be filed with the selected program for television receiving stations 13 and 15, respectively.

Based on the same principle, for example, an e-mail text or teletext or Internet web page information may be displayed in the PIP in other applications.

An embodiment in which the television receiving system 1 is incorporated in a set-top box may alternatively be incorporated in a plug-in card for a computer.

FIG. 3 shows an embodiment in which the processing unit 7 is incorporated in the television receiving station 13, implemented as a picture display device. Incorporated is herein also understood to mean that the system may be a plug-in or an external box which can be connected to the picture display device.

FIG. 4 shows an example of a construction of the second outgoing television signal displayed on television receiving station 15, which is implemented as a picture display device. A dependent user of television receiving station 15 has chosen to utilize the picture display area of the picture display device as follows by specifying the second outgoing television signal. A first sub-area 54 shows a game, in a second sub-area 56 the user watches a television program and, in a third sub-area 58, he reads a message from, for example, a friend. An authorized user of the first television receiving station 13 does not allow the dependent user to watch the television program in sub-area 56. In his turn, the authorized user specifies the second outgoing television signal, so that a cross can be seen through the television program in sub-area 56. Alternatively, the authorized user may, for example, blacken the sub-area 56, or he may add a textual warning to the second outgoing television signal, or even stop the supply of the second outgoing television signal from the processing unit 7. In this case, the specification by the authorized user has always priority over the specification by the dependent user. An added text may alternatively comprise a message which advises, for example, a given television program to the dependent user.

The construction shown in FIG. 4 should exclusively be considered as an example, because many variants are feasible. As regards the sound information in the television signals, the dependent user may select one sound signal from the following set:
one of the sound signals comprised in one of the television programs, or radio programs, at the inputs of the television receiving system 1
an internally generated sound signal, for example, a synthesized speech version of the text in sub-area 58.

Alternatively, a plurality of sound signals may be selected if they can be supplied without any interference to a plurality of users, for example, by means of headphones.

However, the authorized user has the possibility of revoking the sound signal selected by the dependent user and replace it by another sound signal, or of stopping the supply of the sound signal selected by the dependent user.

For other types of information stored in the television signal, such as, for example, teletext, the same rules apply as for picture information or sound signals, dependent on whether the information can be supplied simultaneously with the further types of information to the user by means of actuators of the picture display device. The term actuator is also understood to include an actuator for, for example, fragrance or tactile information.

1. A television receiving system (1) having a first input (3) for a first incoming television signal and a second input (5) for a second incoming television signal, both being coupled to a common processing unit (7) for television signals, and a first output (9) for supplying a first outgoing television signal coming from the processing unit (7) to a first television receiving station (13) comprising a display screen, and a second output (11) for supplying a second outgoing television signal coming from the processing unit (7) to a second television receiving station (15), characterized in that the processing unit comprises means (8) for constructing at least one of the outgoing television signals from the incoming television signals and is capable of processing at least a part of the second outgoing television signal in the first outgoing television signal, the processing unit (7) also comprising user interface software (28) for specifying the outgoing television signals.

2. A television receiving system (1) as claimed in claim 1, characterized in that the first input (3) and the second input (5) are connected to their own tuner (19, 23, respectively).

3. A television receiving system (1) as claimed in claim 1, characterized in that the processing unit (7) is capable of displaying at least a part of the second outgoing television signal on the first television receiving station (13) in accordance with one of the following methods:
the first outgoing television signal is alternated with the second;
the first outgoing television signal covers a part (36) of the display screen of the television receiving station (13), and a scaled version of a selected part of the second outgoing television signal is displayed on a portion of this part (35); and
selected parts of both outgoing television signals are displayed next to each other on the display screen of the television receiving station (13).

4. A television receiving system (1) as claimed in claim 1, characterized in that the processing unit (7) is capable of blocking the supply of the second outgoing television signal to the second output (11).

5. A television receiving system (1) as claimed in claim 1, characterized in that the processing unit (7) is capable of blocking the supply of the first outgoing television signal to the first output (9).

6. A television receiving system (1) as claimed in claim 1, characterized in that the processing unit (7) is incorporated in a set-top box (45).

7. A television receiving system (1) as claimed in claim 1, characterized in that the processing unit (7) is incorporated in the first television receiving station (13).
